(19) United States
(12) Patent Application Publication
(10) Pub. No.: US 2013/0326381 A1
(43) Pub. Date: Dec. 5, 2013

(54) DIGITAL ART PROGRAM INTERACTION AND MECHANISMS

(71) Applicant: MICROSOFT CORPORATION, Redmond, WA (US)

(72) Inventors: Charla Marie Pereira, Seattle, WA (US); Jeffrey Alan Herold, Kirkland, WA (US); Gerard Zytnicki, Seattle, WA (US); Subha Bhattacharyay, Medina, WA (US); Ira L. Snyder, JR., Bellevue, WA (US)

(73) Assignee: MICROSOFT CORPORATION, Redmond, WA (US)

(21) Appl. No.: 13/719,890

(22) Filed: Dec. 19, 2012

Related U.S. Application Data
(60) Provisional application No. 61/652,800, filed on May 29, 2012.

(51) Int. Cl. G06F 3/0484

(52) U.S. Cl. CPC G06F 3/04845
USPC 715/765

(57) ABSTRACT

The subject disclosure is directed towards a digital art program, including user interfaces for user interaction with the digital art program. Described are interactive elements, tools, effects, features, commands and so forth for operating and experiencing the digital art program.

### BACKGROUND

Digital art programs are available on many contemporary computing devices. Some of the programs are designed to be run on a touch-sensitive device, and configured for interaction therewith by a finger or similar pointing device such as a stylus. Any technology that makes such interaction easier and/or more intuitive for users, and/or provides useful features, is desirable with digital art programs.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology in which a digital art program provides a user interface, including elements comprising a palette and art tools. The palette includes a mixing area and paint wells. The art tools include selectable brushes by which a user interacts to add paint from the paint wells to the mixing area and mix the paint into a mixed color paint. The user interface also includes a drawing surface with which the user interacts to add paint from the paint wells via a selected brush, and/or add paint from the mixing area.

In one aspect, there is described receiving touch input on a touch sensitive computing device running a digital art program. The touch input corresponds to selecting a brush digitally displayed by the digital art program, selecting a paint color for the brush from among available paint colors digitally displayed by the digital art program, and applying the paint color selected for the brush to a mixing area or a drawing surface digitally displayed by the digital art program.

In one aspect, there is described providing a digital art program, including outputting an interactive user interface to receive input. The interactive user interface provides a palette for selecting and mixing paint colors based upon user input, a drawing surface for receiving paint strokes via user input, and a surface-related interface for selecting a paper type or canvas type for the drawing surface and a background or background image for the drawing surface.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is an example block diagram showing how a digital art program may be implemented on a computing device according to one example embodiment.

FIGS. 2A and 2B are representations of a user interface for tool selection and palette interaction, and an enlarged interactive palette, respectively, according to one example embodiment.

FIGS. 3A and 3B are representations of user interfaces for selecting colors, according to one example embodiment.

FIG. 4 is a representation of a user interface for tool selection and palette interaction, in a portrait orientation, according to one example embodiment.

FIG. 5 is a representation of a menu for receiving control commands, according to one example embodiment.

FIG. 6 is a representation of a user interface for drawing surface-related selections and actions, according to one example embodiment.

FIG. 7 is a state/flow diagram showing example states and operations of a digital art program, according to one example embodiment.

FIG. 8 is a block diagram representing an example computing environment into which aspects of the subject matter described herein may be incorporated.

### DETAILED DESCRIPTION

Various aspects of the technology described herein are generally directed towards user interaction with a digital art program, including via user interface elements and various mechanisms of such a program that provide useful features. Interaction with the program is accomplished via user interface/user experience (UI/UX) interactions and designs. For example, in one implementation, there are interactive tabs, tools and a drawing surface, each having various associated concepts and technologies as described herein.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and digital art programs in general.

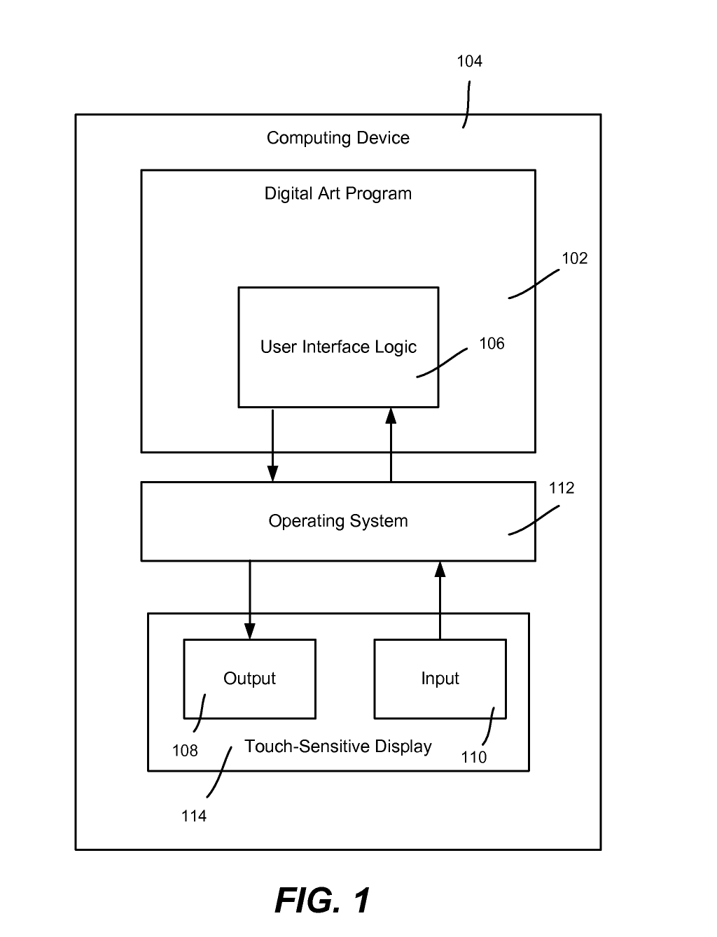

FIG. 1 shows a digital art program 102 running on a touch-sensitive computing device 104. In one implementation, the digital art program 102 includes user interface logic 106 that sends output 108 and receives and processes input 110, via an operating system 112, to and from a touch sensitive display 114 of the computing device 104. As can be readily appreciated, having a touch-sensitive display provides for relatively easy and intuitive interaction via a finger or stylus, however it is understood that any non-touch-sensitive computing device such as a desktop or laptop personal computer may still use the technology described herein via a pointing device such as a mouse, a digitizing tablet, and so forth. Notwithstanding, the examples described herein are generally based upon finger and/or stylus interaction.

As used herein, the terms “paint,” “brush,” “color,” “surface,” “paper,” “canvas” and so on are understood to be digital in nature. For example, a user may select a brush from among various brush types by making a tap gesture on one with a finger or stylus. The user may then insert the brush via a gesture into a paint well of a given color paint via a suitable gesture. The user may then gesture to paint on the surface (e.g., a canvas) with the selected paint color and brush style, with graphics and animation providing the simulation of an actual brush of the selected type applying actual paint to an actual canvas. Selected paint also may be mixed with one or more other colors on the palette as if actual paint was being mixed, to provide for custom colors and color combinations.

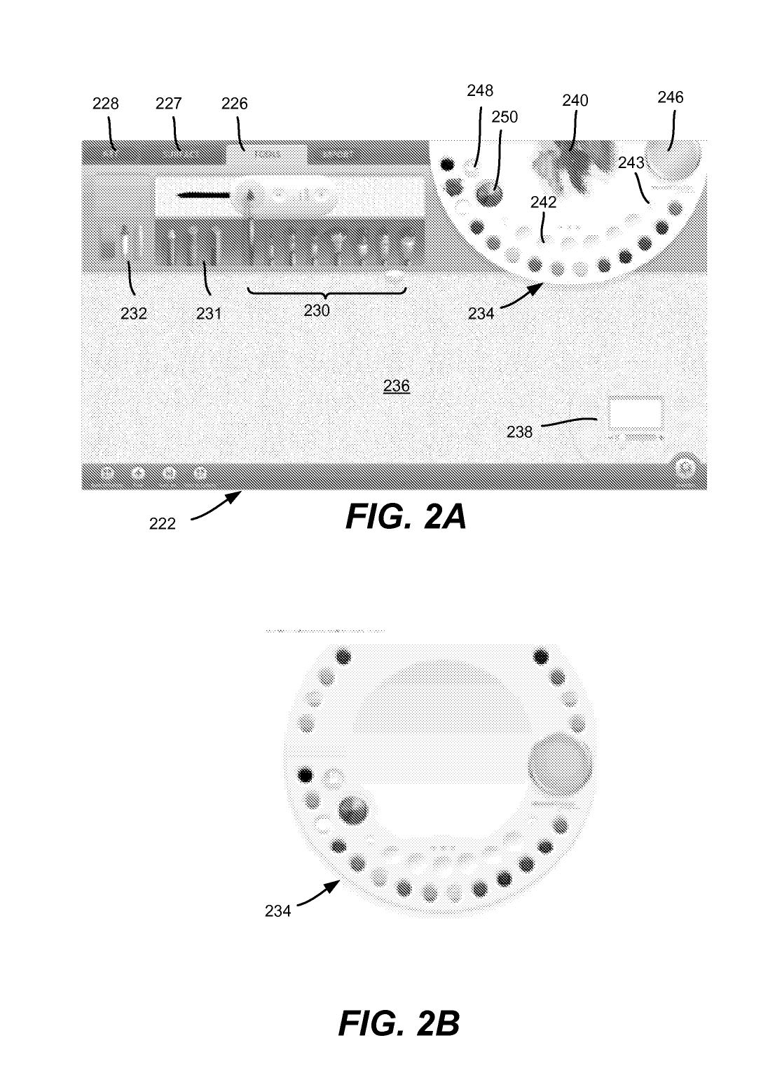

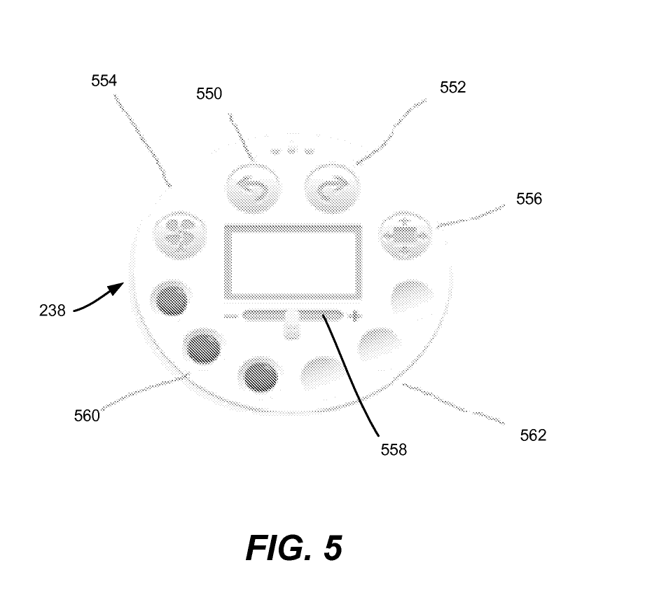

FIG. 2A shows a representation of an example interactive landscape orientation user interface 222 output by the user interface logic 106 when the user has selected a tools tab 226. As generally shown FIG. 2A, elements of the interactive user interface 222 include tabs 226-228, and, when a tools tab is selected, various tools including brushes 230, other input mechanisms 231 (e.g., a pencil, round or square pastel applicators) and other tools 232 (e.g., an eraser, an eyedropper, a blender). Also provided are a palette 234 and a drawing surface 236. The surface 236 may present one or more various drawing surfaces (e.g., a selected type of paper or canvas, e.g., selected via the surface tab 227) on which paint may be applied, or an existing image to which paint may be added. Also shown is a floating menu 238, described below with reference to FIG. 5.

The palette 234 provides a technology by which the user is able to mix digital “oil” and/or “watercolor” paint on a mixing area 240 of the palette, and view any recent colors in wells 242, if any, which can be scrolled among via interactive element 243. The palette 240 also includes a brush cleaning cup 246, which basically acts as a “turpentine” brush cleaning cup for oil paint, or a “water” brush cleaning cup for watercolor paint. The cup 246 may appear and/or otherwise be animated when the color on the brush disappears into the “liquid.” A palette cleaning element 248 clears the mixing area 240 when selected by a user. The user may expand the palette to show more colors and larger mixing area (a generally shown in FIG. 2B).

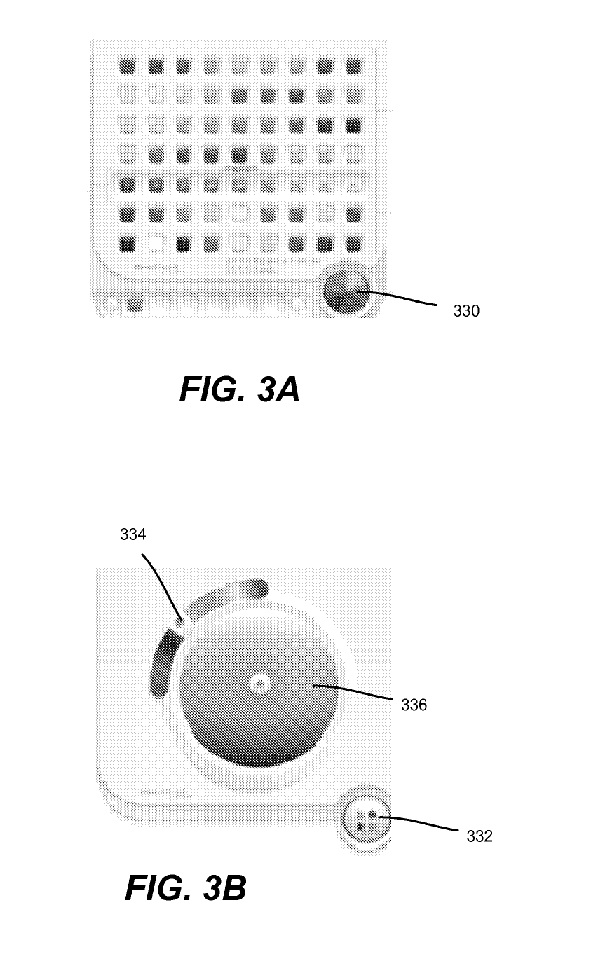

The user can also press a color spectrum chooser element 248 to flip the palette over to show a new design type for a color picker interface element (e.g., allowing all available colors in the spectrum to be chosen and turned into that type of medium). FIGS. 3A and 3B show example interactive color selection mechanisms, which, for example, may be toggled between via elements 330 and 332, respectively. The interactive element 334 facilitates coarse moving in the color spectrum to present a subset of the spectrum in an area 336 for fine selection of a desired color from the area 336.

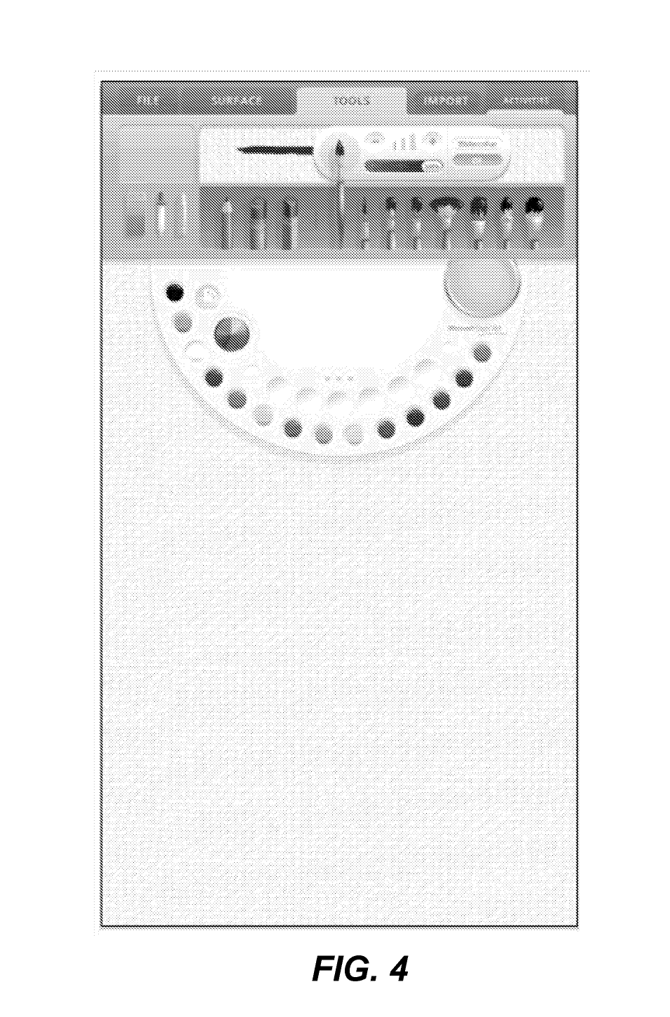

FIG. 4 is a representation of the tools tab-based user interface in the portrait mode. As can be seen, the user has generally the same functionality and interactive elements in either mode.

Turning to the brushes, various effects are provided in one implementation, including showing usage (via wear and tear) and dripping. For example, as each brush is used, the brush is made to appear as progressing through some number of (e.g., three) visual states of wear. In general, the bristles become frayed and the handle becomes smudged and scuffed in appearance. The footprint of the brush with respect to how it transfers paint to the surface 236 need not be altered by such usage, that is, in one implementation, only the brush appearance changes. A visual effect where the brushes drip paint randomly may be provided to provide more realism to the user experience.

FIG. 5 shows additional details of the floating menu 238, which provides for quick access to stroke undo/redo functionality via interactive buttons 550 and 552, surface drying functionality via interactive button 554, pan effects via element 556, and zoom effects via element 558. Wells 560 provide access to recent colors; the wells 532 are empty. The menu 238 may be dragged anywhere on the screen, for example, or may be “docked” to a part of the screen, e.g., the bottom of the screen to reduce its visual footprint while still providing access to undo/redo interaction. The undo button may be used to undo a dry operation, to make the paint wet again; (note that new paint may interact differently when applied to existing wet paint versus existing dry paint).

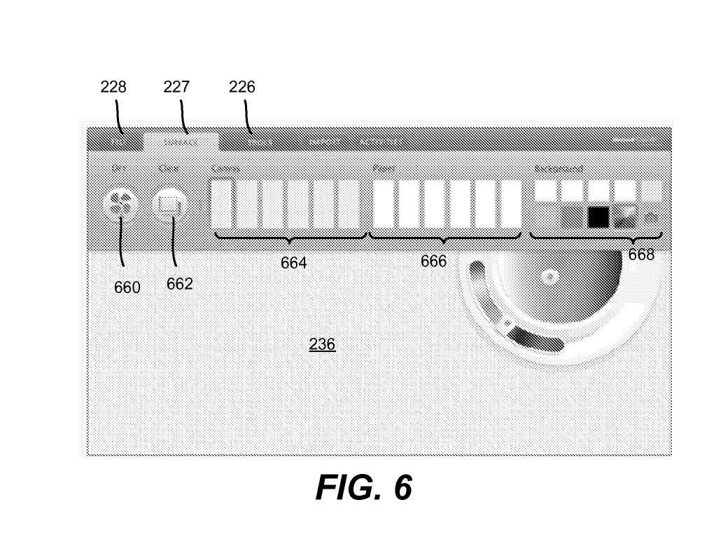

Turning to FIG. 6, the “Surface” tab contains controls that affect the painting/drawing surface 236. Within this tab, the user can dry the paint via element 660, or clear off the surface via element 662. The user may choose from a selection of paper types 664 and canvas types 666, and/or set a background color or image via elements 668. Note that the background color need not be a solid color, and instead, for example, may be a gradient. The user also may rotate the surface orientation via an interactive element, or via gestures described below. As also shown, the digital art program presents the color picker in various locations, including in the palette as described above, in the drawing box and as a background color (among the background selection elements 668).

With respect to gestures, single input gestures may be used, such as with a single finger or stylus, and may include a tap, a double-tap, a drag (move without losing contact with surface), and a flick (quick move). A single input gesture also may include a press-and-drag operation. Dual input gestures (typically via a finger and thumb) include a pinch and a stretch gesture. Other dual input gestures include a rotate gesture, such as with fingers of two hands or a finger and thumb, in which both fingers may make a generally circular motion in the same rotational direction or one finger making a generally circular motion about a point that corresponds to the other finger.

Rotate surface is thus a motion that happens to the surface, allowing for options such painting upside down, painting in portrait orientation or painting in landscape orientation. Other rotational angles may be used in alternative implementations. Note that the rotate surface feature may not apply on tablets in which rotation is controlled by physically rotating the device. In any event, when active, rotation may be via gesture, and/or via an interactive button, and in one implementation rotates the canvas clockwise (and/or counterclockwise is an alternative), with everything staying the same otherwise. This provides the user both portrait and landscape orientations to create their art work, and for an artist to create artwork upside down if desired.

Turning to another aspect, in one implementation, a desk user interface provides a desk/drawer effect from where the tools and surfaces are available. In one implementation, the desk slides across in a transition so that the user may access available elements on one parallel surface, and slides seamlessly across the display screen to provide an interface that the user needs.

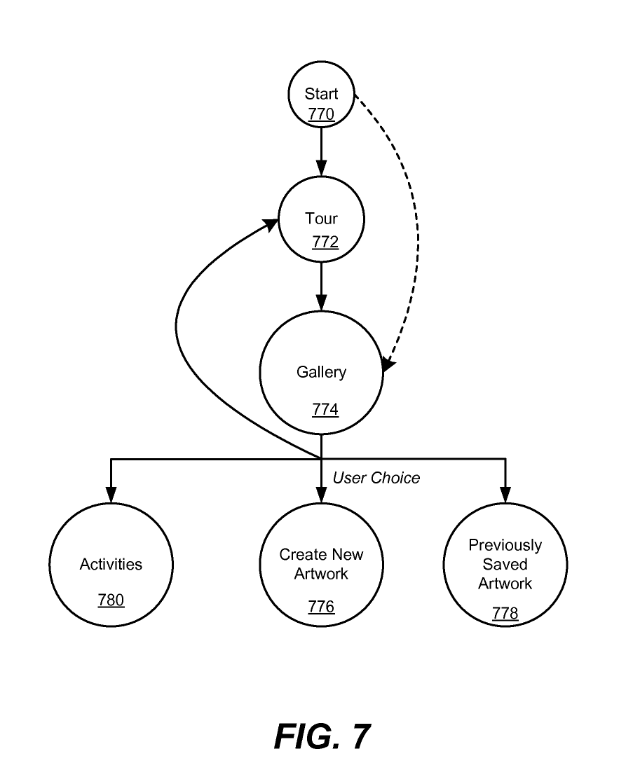

Turning to a general example of flow and state in one example implementation, FIG. 7 shows a start state 770 in which users initially see a start screen (splash) while the program is loading the program application. Users may then take a tour (state 772, which may be skipped), and go into a gallery state 774/screen. Choices from the gallery state/screen include create new artwork 776, open existing artwork 778, activities 780 and take the tour 772. Example activities 780 include activities geared towards children, and information-providing activities, such as to explain techniques, color theory, and give lessons, e.g., including lessons for a starter user to a more advanced user.

The gallery 774 basically provides a home screen for the digital art program, e.g., the state to which a user returns upon closing a file or finishing the watching of a tour; (however, users may transition among activities, create new artwork or select existing artwork without necessarily going through the gallery). For example, artworks created by the user are accessible through the gallery and in one implementation can be browsed by date or title; by default past artwork may be grouped in the gallery, e.g., by month or the like, chronologically from newest to oldest.

Note that in one implementation, upon opening previously saved artwork, the floating menu stays in an inactive state, and remains located wherever the user last placed it (docked or undocked) for that artwork. The zoom level and location may remain set to how the user last left it for that artwork.

### Example Computing Device

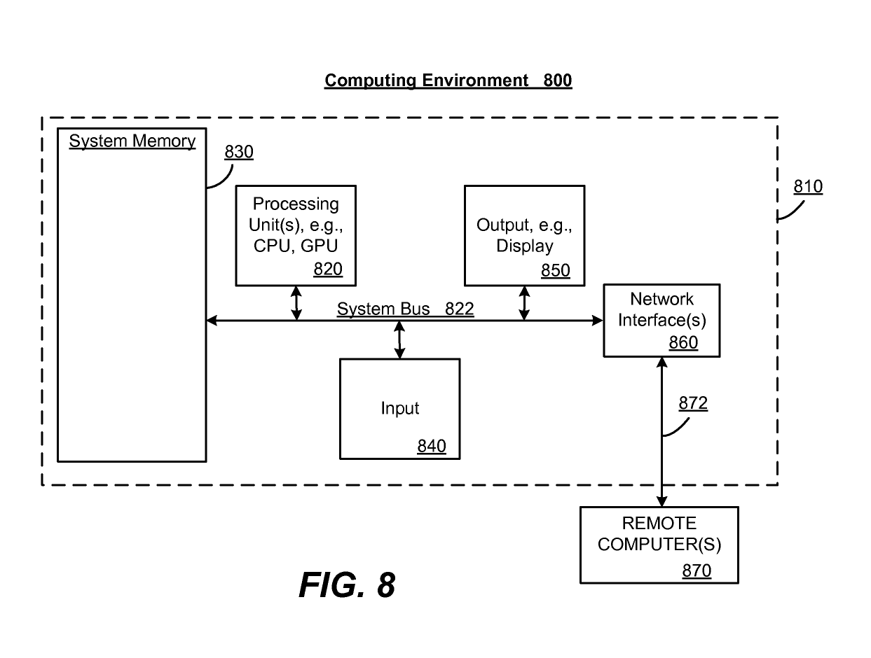

As mentioned, advantageously, the techniques described herein can be applied to any device. It can be understood, therefore, that handheld, portable and other computing devices and computing objects of all kinds including tablets, slates and so on are contemplated for use in connection with the various embodiments. Accordingly, the below general purpose remote computer described below in FIG. 8 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 8 thus illustrates an example of a suitable computing system environment 800 in which one or aspects of the embodiments described herein can be implemented, although as made clear above, the computing system environment 800 is only one example of a suitable computing environment and is not intended to suggest any limitation as to scope of use or functionality. In addition, the computing system environment 800 is not intended to be interpreted as having any dependency relating to any one or combination of components illustrated in the example computing system environment 800.

With reference to FIG. 8, an example remote device for implementing one or more embodiments includes a general purpose computing device in the form of a computer 810. Components of computer 810 may include, but are not limited to, a processing unit 820, a system memory 830, and a system bus 822 that couples various system components including the system memory to the processing unit 820.

Computer 810 typically includes a variety of computer-readable media and can be any available media that can be accessed by computer 810. The system memory 830 may include computer storage media in the form of volatile and/or nonvolatile memory such as read only memory (ROM) and/or random access memory (RAM). By way of example, and not limitation, system memory 830 may also include an operating system, application programs, other program modules, and program data.

A user can enter commands and information into the computer 810 through input devices 840. A monitor or other type of display device is also connected to the system bus 822 via an interface, such as output interface 850. In addition to a monitor, computers can also include other peripheral output devices such as speakers and a printer, which may be connected through output interface 850.

The computer 810 may operate in a networked or distributed environment using logical connections to one or more other remote computers, such as remote computer 870. The remote computer 870 may be a personal computer, a server, a router, a network PC, a peer device or other common network node, or any other remote media consumption or transmission device, and may include any or all of the elements described above relative to the computer 810. The logical connections depicted in FIG. 8 include a network 872, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “example” is used herein to mean serving as an example, instance, or illustration. For the avoidance of doubt, the subject matter disclosed herein is not limited by such examples. In addition, any aspect or design described herein as “example” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. A system comprising, a digital art program that provides a user interface, the user interface including elements comprising a palette and art tools, the palette including a mixing area and paint wells, the art tools including a plurality of selectable brushes by which a user interacts to add paint from the paint wells to the mixing area and mix the paint into a mixed color paint, and a drawing surface with which the user interacts to add paint from the paint wells via a selected brush, or add paint from the mixing area, or both, to add paint strokes to the drawing surface.

2. The system of claim 1 further comprising, a drying interface element with which a user interacts to instruct the digital art program to dry the drawing surface.

3. The system of claim 1 further comprising, a clearing interface element with which a user interacts to instruct the digital art program to clear the drawing surface.

4. The system of claim 1 further comprising, a brush cleaning interface element with which a user interacts to clean a selected brush.

5. The system of claim 1 wherein at least one of the selectable brushes is visibly altered to represent an amount of usage.

6. The system of claim 1 wherein at least one of the selectable brushes is animated to represent dripping paint.

7. The system of claim 1 further comprising, a menu with which the user interacts to provide commands to the digital art program, the menu configured to be moved or docked by user interaction.

8. The system of claim 1 further comprising, a menu with which the user interacts to provide commands to the digital art program, including a dry command, an undo command, a redo command, a pan command or a zoom command, or any combination of a dry command, an undo command, a redo command, a pan command or a zoom command.

9. The system of claim 1 further comprising, an interactive element by which a user obtains a color picker interface.

10. The system of claim 9 wherein the color picker interface comprises a coarse selection element for moving among a color spectrum to provide a subset of colors for selection via a fine selection element.

11. The system of claim 1 further comprising, an interactive element by which a user selects a type of paper or type of canvas for the drawing surface.

12. The system of claim 1 further comprising, an interactive element by which a user selects a visible background or background image for the drawing surface.

13. The system of claim 1 wherein the digital art program receives gesture detection input, including to rotate the drawing surface.

14. The system of claim 1 wherein the digital art program is run on a touch sensitive computing device, and at least part of the user interface in interactive via touch input.

15. A method comprising, receiving touch input on a touch sensitive computing device running a digital art program, the touch input corresponding to selecting a brush digitally displayed by the digital art program, selecting a paint color for the brush from among available paint colors digitally displayed by the digital art program, and applying the paint color selected for the brush to a mixing area or a drawing surface digitally displayed by the digital art program.

16. The method of claim 15 further comprising, receiving input to undo a paint stroke applied to the drawing surface, or receiving input to dry paint applied to the drawing surface.

17. The method of claim 15 further comprising, varying an appearance of the brush to represent an amount of usage of the brush.

18. The method of claim 15 further comprising, receiving input to select a paper or canvas for the drawing surface, to select a background or background image for the drawing surface, or both to select a paper or canvas for the drawing surface and select a background or background image for the drawing surface.

19. One or more computer-readable storage media having computer-executable instructions, which when executed perform steps, comprising, providing a digital art program, including outputting an interactive user interface to receive input, the interactive user interface providing a palette for selecting and mixing paint colors based upon user input, a drawing surface for receiving paint strokes via user input, and a surface-related interface for selecting a paper type or canvas type for the drawing surface and a background or background image for the drawing surface.

20. The one or more computer-readable storage media of claim 19 having further computer-executable instructions comprising, providing a moveable menu, the moveable menu including a dry command, an undo command, a redo command, a pan command or a zoom command, or any combination of a dry command, an undo command, a redo command, a pan command or a zoom command.
